(19) United States
(12) Patent Application Publication
(10) Pub. No.: US 2025/0079618 A1
(43) Pub. Date: Mar. 6, 2025

(54) STORAGE DEVICE, CELL MODULE, COMPONENT SET, SEALING ELEMENT SUPPORT, AND PRODUCTION METHODS AND USES RELATED THERETO

(71) Applicant: ElringKlinger AG, Dettingen (DE)

(72) Inventors: Eugen KÜBLER, Owen (DE); Martin NEDELE, Reutlingen (DE)

(73) Assignee: ElringKlinger AG, Dettingen (DE)

(21) Appl. No.: 18/950,029

(22) Filed: Nov. 16, 2024

Related U.S. Application Data
(63) Continuation of application No. PCT/EP2023/063705, filed on May 22, 2023.

(30) Foreign Application Priority Data
May 23, 2022 (DE) 10 2022 112 881.4

(51) Int. Cl. H01M 50/289; H01M 10/6567; H01M 50/213

(52) U.S. Cl. CPC H01M 50/289; H01M 10/6567; H01M 50/213; H01M 2220/20

(57) ABSTRACT

The invention relates to a storage device (200) for receiving, storing and releasing electrical energy, the storage device (200) comprising the following: a storage cell (140); a packing unit (110), the packing unit (110) exhibiting a sealing element (120); and a temperature control zone (130) on one side of the packing unit (110), wherein at least one region of the storage cell (140) extends into the temperature-control zone (130); wherein the sealing element (120) surrounds a cell casing (144) of the storage cell (140) and delimits the temperature-control zone (130) from an adjacent zone.

### RELATED APPLICATION

This application is a continuation of international application No. PCT/EP2023/063705 filed on May 22, 2023, and claims the benefit of German application No. 10 2022 112 881.4 filed on May 23, 2022, which are incorporated herein by reference in their entirety and for all purposes.

### FIELD OF DISCLOSURE

The present invention relates to the field of storage devices for receiving, storing and releasing electrical energy.

As a result of growing electromobility, storage devices for receiving, storing and releasing electrical energy are acquiring ever greater importance, since they make available the energy needed for the propulsion of vehicles.

In principle, the receiving and releasing of electrical energy may be based upon electrochemical reactions or upon physical charge transfers.

If the receiving and releasing are based upon electrochemical reactions, the storage device may preferably be a battery device. If the receiving and releasing are based upon physical charge transfers, the storage device may preferably be a capacitor device.

Three cell systems, in particular, are customary for battery devices: cylindrical cells, prismatic cells and pouch cells.

In particular, cylindrical or prismatic cells can be inserted directly during assembly into holding devices of a battery module which are provided for this purpose. The cells are retained mechanically or by material closure. Additional cooling systems are needed, which may include cooling pipes and/or cooling plates, for example.

Such a battery module can be produced only with relatively great effort. This is because the storage cells have to be inserted into the holding devices, and cooling pipes and/or cooling plates have to be integrated. The mechanical or materially closed linking of the storage cell may, in addition, hamper or prevent a necessary tolerance compensation of the storage cell in the module.

### BACKGROUND

DE 10 2015 013 800 A1 describes a battery adhesion-fixation structure comprising a plurality of battery cells, a holder, an adhesive agent, a plurality of busbars and an insulator. The holder includes a plurality of retaining holes. The adhesive agent bonds or connects the battery cells to the holder. The insulator is situated between the busbars and the holder. Retaining holes are also designated as retaining bores. The diameter of the retaining holes appears to be constant over the length of the retaining holes. The adhesive agent is arranged between an inner peripheral surface of the retaining holes and an outer peripheral surface of the battery cells.

DE 10 2018 218 343 A1 describes a cell-housing plate for the arrangement of round cells, comprising a cover plate arranged on the upper side of the cell-housing plate and also a base plate arranged opposite the cover plate on the underside of the cell-housing plate, the cover plate and the base plate exhibiting a plurality of recesses arranged opposing one another for receiving the round cells, the recesses each exhibiting a collar, pointing radially toward the interior of the recesses, for receiving a sealing material, and an opening, arranged within the collar, for feeding the round cells through, the cover plate and the base plate being arranged in relation to one another in such a manner that the recesses of the cover plate and the recesses, arranged in opposing manner, of the base plate constitute cavities for receiving sealing material for sealing off the round cells that are capable of being arranged within the cell-housing plate.

DE 10 2018 218 343 A1 also describes cavities, arranged in the interior of the cell-housing plate, for receiving sealing material, as well as openings, arranged within the collar, for receiving round cells. After round cells have been inserted into the opening, sealing material can be introduced into the cavities via the opening, in the course of which the air that is present within the cavities is vented via an opening provided for the purpose of discharging air.

In DE 10 2014 106 852 A1 a battery module is described. This module exhibits a frame-like battery box in which a large number of cylindrical, vertically-oriented battery cells have been inserted. An interspace between the battery cells and the battery box is to have been filled, in fluid-tight manner, with an insulating layer consisting of a cured grouting compound.

According to DE 10 2014 106 852 A1, below the insulating layer an upper retaining plate connected to the battery box has been provided, with which the battery cells have been suitably arranged and aligned. A sealing mat has been provided between the upper retaining plate and the insulating layer, which in the course of the grouting of the grouting compound for the insulating layer rests on the upper retaining plate and prevents the grouting compound from being able to flow through a clearance fit formed between the upper retaining plate and the battery cell and/or between the upper retaining plate and the battery box.

According to DE 10 2014 106 852 A1, a lower retaining plate, a further sealing mat arranged below the lower retaining plate, and a further insulating layer arranged below the further sealing mat have been provided in the lower region of the battery module, substantially symmetrically. By means of the battery box, the insulating layer and the further insulating layer, a cooling chamber is intended to have been formed, in which a cooling fluid is able to flow around some of the battery cells arranged in the cooling chamber, in order to dissipate heat and to cool the battery cells.

DE 10 2014 106 852 A1 accordingly provides at each of the two ends of the battery cells a relatively complicated three-layer structure comprising, in each instance, an insulating layer, a sealing mat and a retaining plate.

### SUMMARY OF THE INVENTION

The object underlying the present invention is to make available a storage device that is capable of being produced with little effort and capable of being temperature-controlled efficiently, as well as components for such a storage device. In particular, the storage device is to be able to compensate well for the tolerances of the shape of a storage cell.

In accordance with the invention, this object is achieved by virtue of the features of claim 1.

The storage device according to the invention can be produced with little effort. First of all, a cell module of the desired size—that is to say, for example, with X cell rows, each cell row comprising Y cells—can be provided and can be inserted as a unified block into a housing element of a storage device that is being formed. The numbers X and Y can be chosen freely within wide ranges. With the aid of the packing unit, which can act at the same time as a boundary element, one or two temperature-control zones, through which a temperature-control fluid is capable of flowing, can be defined.

At the same time, the storage device according to the invention is capable of being temperature-controlled efficiently. This is because a typical storage cell exhibits a fluid-tight cell casing anyway, which bounds the storage cell toward the outside. In accordance with the invention, a region of the cell casing of a storage cell may, for example, extend directly into the temperature-control zone through which the temperature-control fluid is capable of flowing. Heat can be supplied or dissipated particularly efficiently with the flow of the temperature-control fluid.

In addition, the storage device according to the invention is able to compensate well for tolerances of the shape of a storage cell. Regions of a storage cell that extend into the temperature-control zone through which the temperature-control fluid is capable of flowing may be deformed in the usual way in the course of the charging or discharging of the cell without colliding with a wall of a holding device. A region of the storage cell that extends into the temperature-control zone is preferably not in contact with a wall of a holding device but extends into a temperature-control fluid which is able to flow around the storage cell substantially independently of any deformations of the storage cell.

The storage device for receiving, storing and releasing electrical energy may be an electrochemical storage device or a capacitive storage device or an electrochemical and capacitive storage device.

It may be a question of a storage device for an entirely or fully electrically powered vehicle. The term “vehicle” encompasses a land vehicle (for example, a road vehicle or a rail vehicle), an aircraft (for example, an airplane) and a watercraft (for example, a ship).

The storage device includes a storage cell. Of course, the storage device may include one or more storage cells, for example a large number of further storage cells.

The storage cell is preferably a battery cell or a capacitor cell.

The battery cell is preferably a rechargeable battery cell. The battery cell may be a rechargeable lithium-ion battery cell, for example.

The storage cell may be, for example, a cylindrical storage cell or a prismatic storage cell, preferably a cylindrical storage cell.

The capacitor cell may contain a capacitor, for example. The capacitor may preferably be a supercapacitor or a double-layer capacitor, particularly preferably a supercapacitor.

The supercapacitor can, for example, enable a static storage of electrical energy by charge separation in Helmholtz double layers in a double-layer capacitor, and can additionally enable an electrochemical storage of electrical energy by Faraday charge exchange with the aid of redox reactions in a pseudocapacitor. It is known that the double-layer capacitance and pseudocapacitance add up to a total capacitance in a so-called supercapacitor which may be contained in the capacitor cell.

The storage device includes a packing unit. The packing unit exhibits a sealing element.

The sealing element may be a synthetic sealing element, for example an elastomer sealing element.

The sealing element may be a packing ring. The cross-section of the packing ring may be angular or round, for example. In the unpressed state, the packing ring may have a round cross-section, for example an O-shaped cross-section. The sealing element may accordingly be an O-ring, for example.

It may be particularly advantageous if a grouting compound constitutes the sealing element or a part of the sealing element.

The storage device includes a temperature-control zone on one side of the packing unit. At least one region of the storage cell extends into the temperature-control zone.

The sealing element surrounds a cell casing of the storage cell and delimits the temperature-control zone from an adjacent zone.

The sealing element may, for example, extend around a region of the cell casing of the storage cell and, as a result, may surround the cell casing.

The sealing element can, for example, bring about or promote a sealing separation of the temperature-control zone from the adjacent zone, in particular a sealing separation to counter a transfer of a temperature-control fluid, for example an aqueous temperature-control fluid.

The sealing element can counteract a leakage of a temperature-control fluid along the cell casing out of the temperature-control zone.

The storage cell may, for example, have been received in a recess of the packing unit. The sealing element can seal a gap between the cell casing and the margin of the recess.

The packing unit may preferably exhibit a sealing-element support. The sealing element may have been pressed against the cell casing by the sealing-element support.

It may be particularly advantageous if the grouting compound is arranged directly on a surface of the sealing-element support.

The grouting compound may extend directly as far as the cell casing.

Each sealing-element support described herein may be a metal sealing-element support, for example made of a steel or aluminum, or a synthetic sealing-element support, for example a synthetic sealing-element support obtainable by injection molding.

The sealing-element support preferably includes a large number of recesses of the same kind and/or of the same shape. The recesses may have been arranged regularly. For example, the midpoints of, in each instance, several recesses may lie on straight lines extending parallel to one another. Three midpoints of three recesses directly adjacent to one another may constitute an isosceles triangle, preferably an equilateral triangle, by way of the three line-segments that connect the midpoints of the recesses. The recesses of the same kind and/or of the same shape may serve for receiving storage cells of the same kind and/or of the same shape.

It may be particularly advantageous if the sealing-element support exhibits an insertion slope and the insertion slope faces toward the cell casing and is inclined in relation to the surface of the cell casing. The insertion slope may preferably extend all around the cell casing.

The spacing between directly adjacent recesses may advantageously amount to at most 5 mm, particularly advantageously at most 3 mm, quite particularly advantageously at most 2 mm, for example at most 1.5 mm. If one or more directly adjacent recesses exhibit insertion slopes, the spacing from narrow region to narrow region is determined.

It has been shown that the small storage-cell spacings resulting from this may suffice for sufficient cooling, and consequently a high energy density and power density can be achieved at the same time.

The insertion slope may extend from a wide region of the recess to a narrow region of the recess.

In the region of the insertion slope, the recess may extend substantially conically from the wide region to the narrow region.

In the wide region, a diameter of the recess may be at most 3 mm, preferably at most 2 mm, particularly preferably at most 1 mm, for example at most 0.6 mm, larger than a diameter of the recess in the narrow region.

In the wide region, a diameter of the recess may be at least 0.05 mm, preferably at least 0.1 mm, particularly preferably at least 0.15 mm, for example at least 0.2 mm, larger than a diameter of the recess in the narrow region.

If the recess is not circular, the diameters in the wide region and narrow region can be measured, for example, across the recess at the point at which the recess has the largest diameter.

Adherence to the differences, specified above, of the diameters in the wide region and narrow region can enable reception of the storage cell by the wide region without difficulty and, at the same time, can make possible an extremely small gap dimension in the region of the narrow region. This can, in particular, permit the application of grouting compounds of low viscosity which can be applied quickly, from which the sealing element can be produced, and with which a connection of the sealing-element support to the cell casing can be established at the same time. This is because a small gap dimension at the narrow region ensures, even in the case of a low-viscosity grouting compound, that, as far as possible, no grouting compound can seep through between the narrow region and the cell casing and get into the temperature-control zone.

The sealing-element support may preferably be a boundary element of the temperature-control zone, for example a boundary plate. The boundary element of the temperature-control zone, for example the boundary plate, can, together with the sealing element and the storage cell, preferably together with a large number of sealing elements and storage cells, delimit the temperature-control zone from the adjacent zone.

The sealing-element support may exhibit at least one conduit for a temperature-control fluid. In particular, if the adjacent zone is a further temperature-control zone, a transfer of temperature-control fluid out of the temperature-control zone into the adjacent zone may be desired.

A temperature-control fluid can be conducted through the temperature-control zone, routed through the at least one conduit into the further temperature-control zone, and then conducted through the further temperature-control zone.

The number of temperature-control zones of the storage device may amount to, for example, 1 to 20, preferably 1 to 16, particularly preferably 1 to 8. Adjacent temperature-control zones may have been separated by, in each case, a packing unit and/or by a molded element described herein, in which case at least one conduit, for example at least one conduit in a sealing-element support of the packing unit or in the molded element, enables a transfer from an upstream temperature-control zone in the direction of flow of the temperature-control fluid into a downstream temperature-control zone in the direction of flow of the temperature-control fluid.

Several regions of the storage cell succeeding one another along the longitudinal axis of the storage cell may extend into various temperature-control zones. A molded element described herein may be situated between two temperature-control zones and may separate the two temperature-control zones.

The regions of the storage cell succeeding one another along the longitudinal axis of the storage cell, which may extend into various temperature-control zones, may succeed one another indirectly or directly. If a molded element described herein is situated between two temperature-control zones and separates the two temperature-control zones, the regions of the storage cell succeeding one another along the longitudinal axis of the storage cell, which extend into various temperature-control zones, may succeed one another indirectly. Between the regions of the storage cell succeeding one another indirectly, which extend into various temperature-control zones, a portion of the storage cell may be situated that extends through the molded element. The portion of the storage cell that extends through the molded element may have been received in a receiving zone of the molded element.

In comparison with a storage device with only one temperature-control zone, this may be advantageous, since a substantially uniform temperature control of all the cells with more than one temperature-control zone can be achieved with less effort. For this purpose, a stream of temperature-control fluid can, for example, be conducted in such a way that a first storage cell in a temperature-control zone in the stream of temperature-control fluid is arranged upstream in relation to a second storage cell, but in the adjacent temperature-control zone the second storage cell is arranged in the stream of temperature-control fluid upstream in relation to the first storage cell. Although the temperature of the temperature-control fluid flowing through the temperature-control zones changes continually, the first and second storage cells are then temperature-controlled substantially uniformly overall—considered across both temperature-control zones. Of course, the number of storage cells in a storage device is typically much higher than two, but the considerations that have been stated may hold for any pair of two cells from a large number of cells.

The observation in the preceding paragraph holds, in particular, if the temperature-control fluid is conducted in counterflow in the two adjacent temperature-control zones.

It may be preferred if the number of temperature-control zones of the storage device amounts to at least two, if several regions of the storage cells succeeding one another along the longitudinal axis of several storage cells extend into adjacent temperature-control zones of the storage device, and if one or more inlets, conduits and outlets have been formed in such a way that the main flow directions of a temperature-control fluid that is capable of being conducted through adjacent temperature-control zones into at least two adjacent temperature-control zones are substantially opposed. “Substantially opposed” means that the angle between the main flow directions amounts to 180°±40°,preferably 180°±25°.

It may be particularly advantageous if the region of the storage cell extends through the temperature-control zone as far as a further packing unit, and if both packing units preferably each exhibit a sealing-element support.

It may be particularly advantageous, in particular, if the storage cell extends through a single temperature-control zone. The temperature-control zone may be bounded by two sealing-element supports. It may be preferred if at least 50% of the surface area of the cell casing, for example at least 65% of the surface area of the cell casing, comes to be situated in the temperature-control zone. “The surface area of the cell casing” is understood to mean the surface area of the storage cell that extends from one end face to the other end face of the storage cell. This may be particularly advantageous, since two sealing-element supports can be arranged on the storage cell in technically particularly simple manner, as will be explained herein by way of example, in particular with reference to FIGS. 14 and 15.

It may be particularly advantageous, in particular, if a grouting compound is arranged at least on a surface of a sealing-element support facing away from the temperature-control zone, the grouting compound constitutes a sealing element and connects the cell casing to the surface of the sealing-element support facing away from the temperature-control zone, and/or to the insertion slope.

It may be particularly advantageous, in particular, if both sealing-element supports each exhibit an insertion slope and the insertion slopes each face toward the cell casing and are inclined in relation to the surface of the cell casing.

Both insertion slopes may preferably extend around the cell casing.

Both insertion slopes may preferably be inclined in the same direction.

This may mean, in particular, that a storage cell received in the two recesses of the two sealing-element supports extends, proceeding from one end of the storage cell to the other end of the storage cell, firstly through the wide region and then through the narrow region of the recess of one sealing-element support and, spaced by the temperature-control zone, subsequently through the wide region and then through the narrow region of the recess of the other sealing-element support.

A sealing-element support may exhibit at a recess a narrow region facing toward the temperature-control zone. The other sealing-element support may exhibit at a recess a wide region facing toward this temperature-control zone.

Furthermore, it is possible that a sealing-element support, the recess of which exhibits a wide region facing toward the temperature-control zone, exhibits, in addition to this wide region and the narrow region thereof, a further wide region facing away from the temperature-control zone. An hourglass-like surface contour may result, with a narrow region arranged between two wide regions.

It may be particularly advantageous, in particular, if a grouting compound is arranged on each of the two surfaces of the two sealing-element supports facing away from the temperature-control zones.

The respective grouting compound may constitute, in each instance, the sealing element of the sealing-element support on the surface of which it is arranged. The respective grouting compound is able to connect the cell casing to the surface of the sealing-element support facing away from the temperature-control zone, and/or to the insertion slope.

If the sealing-element support, the recess of which exhibits a wide region facing toward the temperature-control zone, exhibits, in addition to this wide region and the narrow region thereof, a further wide region facing away from the temperature-control zone, grouting compound may be located in the further wide region. This can be advantageous in order to enhance the sealing action further in the region between the cell casing and this recess.

At least one packing unit of the storage device, for example the further packing unit, may preferably be a molded element. Alternatively, or in addition to the possibility that at least one packing unit, for example the further packing unit, is a molded element, the temperature-control zone may be bounded by a molded element.

It may be particularly advantageous if the temperature-control zone is bounded by the molded element. The temperature-control zone may be bounded on one side of the temperature-control zone by a packing unit described herein, and bounded on an opposing side of the temperature-control zone by the molded element.

The molded element may comprise a molded-element material, and the density of the molded element may advantageously amount to at most 0.75 g/cm³, may preferably amount to at most 0.65 g/cm³, may particularly preferably amount to at most 0.55 g/cm³.

It is preferred if the molded-element material exhibits cavities, for example pores.

It is particularly preferred if the molded-element material contains particles and the particles exhibit voids, for example pores.

The molded-element material may be, for example, a particle-foam material.

The storage cell may have been received in a receiving zone of the molded element. At the receiving zone the molded element may extend around a region of the storage cell received in the receiving zone.

The storage cell may have been fixed to the molded element in the receiving zone, for example by an interference fit.

The receiving zone may taper. The receiving zone may, for example, taper in conically tapering manner.

The receiving zone may exhibit an insertion portion and an interference-fit portion. In the insertion portion a cross-section of the receiving zone may be larger than a cross-section of the storage cell. In the interference-fit portion the storage cell may have been fixed to the molded element in the receiving zone by interference fit.

The packing unit may preferably be arranged in at least one suspension zone on at least one housing element of the storage device. For this purpose, the at least one housing element and/or the packing unit may exhibit a suspension element.

The storage device may exhibit at least one cell module according to the invention, in which case the stated storage cell(s), packing unit(s) with sealing element(s) and sealing-element support(s) may be encompassed by the cell module.

The cell module may be an interchangeable unit of the storage device.

This may have the advantage that neither an entire storage device nor individual storage cells have to be exchanged if the storage cells are depleted after a large number of charging cycles. An exchange of the individual cells would be very labor-intensive. In the course of the exchange of the entire storage device, components that are not worn out—for example, also housing components—would also be exchanged unnecessarily. From an ecological and economic point of view, this should be avoided, since the housing components are often high-quality, fiber-reinforced lightweight components that can protect storage cells from mechanical damage and, for example, bring about intrusion protection in electrically powered vehicles.

The storage device may include a receiving region in which at least one marginal region of a packing unit or at least one marginal region of a sealing-element support encompassed by a packing unit can be received. The storage device is preferentially endowed on the receiving region with a margin-receiving sealing element, and/or the marginal region is endowed with a margin-receiving sealing element. The margin-receiving sealing element can also contribute toward ensuring that the temperature-control zone of the storage device is delimited from the adjacent zone.

In accordance with the invention, the object is also achieved by virtue of the features of claim 8.

The features and advantages specified herein at another place, for example in connection with the storage device, may preferably also hold for the cell module. This also holds conversely.

The cell module and/or the storage device may, in addition, preferably include a further packing unit, in which case the further packing unit exhibits a further sealing element and a further sealing-element support; in which case the further sealing element also surrounds the cell casing of the storage cell, and in which case a region of the storage cell extends between the packing units through a temperature-control zone which is bounded by the two packing units.

The sealing-element support may comprise a first support region and a second support region, and a region of the sealing element may have been arranged between the two support regions.

The support regions may, for example, extend at a distance from one another and along the two surfaces of the sealing-element support.

The sealing-element support may exhibit a recess for receiving the storage cell. A margin of the first support region and a margin of the second support region may extend as far as the recess. The recess may exhibit an encircling depression between the margin of the first support region and the margin of the second support region. The region of the sealing element that is arranged between the two support regions may have been arranged in the encircling depression.

An edge on the margin of the first support region and an edge on the margin of the second support region may have been formed in such a way that the region of the sealing element is received in a depression defined by the two edges. This depression may be the encircling depression.

The first and second support regions may extend as far as a connection region of the sealing-element support. The sealing-element support preferably includes a large number of connection regions. The connection region (preferably the connection regions) takes up a total of 2% to 30%, for example 4% to 25%, of the area of the sealing-element support. In this connection, solely the area covered by the sealing-element support is considered as the area of the sealing-element support. A sealing-element support without sealing elements and without storage cells is taken as a basis. The area taken up by recesses accordingly does not contribute to the area covered by the sealing-element support.

It may be preferred if the first and second support regions have been connected to one another, for example have been hot-caulked, in a connection region, preferably in several or all of the connection regions, by force closure, by form closure and/or by material closure.

By the term “hot caulking” herein, any form of hot caulking is meant, inclusive of classical hot caulking with a heated punch and contactless hot caulking which includes, for example, laser hot caulking and also infrared hot caulking.

The hot-caulking device can preferably generate a sealing-element support consisting of sealing-element-support parts, or can act on a sealing-element support and thereby generate or strengthen a force that presses the sealing element more firmly onto the cell casing.

The sealing-element support may comprise two sealing-element-support layers connected in at least one connection region over a partial area, for example by hot caulking. The layers of the sealing-element support preferably extend over the entire area of the sealing-element support, in which case recesses of the sealing-element support coincide with mutually congruent recesses of the connected layers of the sealing-element support.

This may be advantageous with regard to efficient manufacture. For example, the sealing elements may be arranged on the storage cells. This can be done in automated manner. The storage cells can subsequently be inserted into the recesses of a layer of the sealing-element support, in which case the sealing element constitutes a stop which prevents the storage cells from falling through the recesses. Subsequently the second layer of the sealing-element support is applied, so that on each storage cell a sealing element comes to be situated between the recess margins of the two layers of the sealing-element support. Then the connections of the layers of the sealing-element support are generated, for example by hot caulking. This may have the effect that the sealing element which has been squeezed in between the layers of the sealing-element support is pressed onto the cell casing.

The sealing element may have been pressed so firmly against the cell casing that a force F acting along a longitudinal axis of the storage cell that corresponds to 20 times, preferably 30 times, especially 50 times, for example 60 times, the magnitude of a weight force G acting on the storage cell is not sufficient to pull the storage cell out of the pressed-on sealing element. For a person skilled in the art and having knowledge of the invention, It is readily possible to choose the two layers of the sealing-element support and also the material and thickness thereof in such a way that an appropriately high contact pressure of the sealing element on the cylindrical surface can be achieved.

Particularly preferably, the sealing-element support may have been hot-caulked.

As a consequence of the hot caulking, the sealing element may have been pressed against the cell casing.

The first support region may be a cover region, and the second support region may be a base region. A base region may be a depressed region on a surface of a base element of a sealing-element support that extends as far as a recess of the base element of a sealing-element support. A cover element of a sealing-element support that exhibits the cover region may have been arranged in the depressed region and may likewise extend as far as the recess. The cover element of the sealing-element support may exhibit a recess that coincides with a recess of the base element of the sealing-element support, so that the two recesses together constitute the recess of the sealing-element support. The depressed region and the cover element of the sealing-element support, arranged therein, may be ring-shaped or washer-shaped.

A packing portion of the sealing element may extend between the two support regions, for example between the cover region and the base region.

The sealing element may have been connected to the sealing-element support by material closure.

The sealing element may have been connected to the support regions, for example to the cover region and to the base region, by material closure. In particular, the packing portion may have been connected to the support regions, for example to the cover region and to the base region, by material closure.

Such materially closed connections can be obtained, for example, if a sealing-element support is provided that exhibits a recess for receiving a storage cell and includes a packing feed opening and a duct region, in which case the duct region extends from the packing feed opening as far as the recess. The duct region may, for example, be bounded by the first support region and by the second support region. The recess of the sealing-element support can be endowed with a sealing element, by a liquefied packing material being conveyed through the packing feed opening and the duct region into the recess.

It is possible that the duct region extends between the cover region and the base region.

Through the choice of a suitable combination of the material of the sealing-element support and of the packing material, and also of the temperature of the sealing-element support and of the liquefied packing material, the materially closed connection arises. The materially closed connection may exist, for example, across the packing material from the cover element of the sealing-element support to the base element of the sealing-element support.

On the other hand, materials and temperatures can also be chosen in such a way that a materially closed connection of the sealing element to the sealing-element support does not arise.

The sealing element may have been connected by form closure and/or by force closure to the support regions, for example to the cover region and to the base region. In particular, the packing portion may have been connected by form closure and/or by force closure to the support regions, for example to the cover region and to the base region. In this case, there may or may not be a materially closed connection in addition.

A form closure and/or force closure may arise (where appropriate, in addition to an optional material closure), for example, if the liquefied packing material is conveyed into the recess through the packing feed opening and the duct region.

The sealing element may, for example, have been attached by material closure to a surface of the sealing-element support facing toward the cell casing.

The sealing element may preferably have been attached by injection molding to the surface of the sealing-element support facing toward the cell casing.

The sealing element may have been attached, for example by hot caulking, to a surface of the sealing-element support facing toward the cell casing. The heat supplied to the sealing-element support or to the layers of the sealing-element support, in particular heat supplied in the course of the hot caulking, can, for example, be chosen in such a way that the transition region from the sealing-element support to the sealing element becomes so warm that the surfaces of sealing-element support and sealing element are connected by material closure.

It may be particularly advantageous if the storage device and/or the cell module exhibit(s) a grouting compound, in which case:
the grouting compound constitutes the sealing element,
the grouting compound connects the sealing element to the sealing-element support, and/or
the grouting compound connects the storage cell to the sealing-element support.

The grouting compound may be, for example, fusible, pourable, curable, foamable and/or hardened. The fusible and/or flowable grouting compound may, in particular, be based on thermoplastic. The hardened and/or curable grouting compound may, in particular, be resin-based, for example based on synthetic resin. A foamable grouting compound may, for instance, be PU-based.

At least one packing unit of the cell module, for example the further packing unit, may preferably be a molded element. Alternatively, or in addition to the possibility that at least one packing unit, for example the further packing unit, is a molded element, the temperature-control zone may be bounded by a molded element.

It may be particularly advantageous if the temperature-control zone is bounded by the molded element. The temperature-control zone may be bounded on one side of the temperature-control zone by a packing unit described herein, and bounded on an opposing side of the temperature-control zone by the molded element.

The molded element may comprise a molded-element material that was described in detail in connection with the storage device.

The storage cell may preferably have been received in a receiving zone of the molded element. At the receiving zone the molded element may extend around a region of the storage cell received in the receiving zone.

The storage cell may have been fixed to the molded element in the receiving zone, for example by an interference fit.

The receiving zone may taper.

The receiving zone may, for example, taper in conically tapering manner.

The receiving zone may exhibit an insertion portion and an interference-fit portion. In the insertion portion, a cross-section of the receiving zone may be larger than a cross-section of the storage cell. In the interference-fit portion, the storage cell may have been fixed to the molded element by interference fit in the receiving zone.

Even if the storage device does not include a (replaceable) cell module, the storage cell(s), the packing unit(s) and the sealing element(s) and also, where appropriate, sealing-element supports, for example, in the storage device may be of such a nature and may interact with one another as described herein, in particular in connection with the cell module.

In accordance with the invention, the object is also achieved by virtue of the features of claim 14.

The carrier may have been arranged or formed between several recesses on the other sealing-element support.

The carrier may preferably constitute a stop of the storage cell. The stop of the storage cell can set a maximum reception depth of a storage cell that is capable of being received in the recess. The “reception depth” is understood to mean the distance that a storage cell can travel within the recess in the direction toward the stop until it comes into contact with the stop of the storage cell.

In particular, a stop portion of the carrier may extend at a distance from the recess and may overlay there, wholly or partially, a recess area taken up by the recess.

The carrier arranged or formed between several (for example, three) recesses on the other sealing-element support may constitute, at the same time, a stop for several (for example, three) storage cells which sets a maximum reception depth of the storage cells that are capable of being received in these recesses. It may, for example, be a question of a carrier made of metal which has been attached to a metal sealing-element support. Three stop portions, for example, may extend in three directions at a distance from three adjacent recesses and may respectively overlay, wholly or partially, one of the three recess areas taken up by the recesses.

Several carriers (for example, all the carriers) may each extend, inclined in the same direction, on a synthetic sealing-element support. This can bring about the advantage that the synthetic sealing-element support, inclusive of the carriers formed thereon, can be produced on the piece by injection molding and can be removed from the injection mold without destroying the carriers that have been formed.

In accordance with the invention, the object is also achieved by virtue of the features of claim 16.

The sealing-element support according to the invention may also be a sealing-element support described herein as another or a further sealing-element support. Said support may accordingly, for example, also exhibit a carrier.

The spacing between directly adjacent recesses may particularly advantageously amount to at most 3 mm, quite particularly advantageously at most 2 mm, for example at most 1.5 mm.

In accordance with the invention, the object is also achieved by virtue of the features of claim 17.

The attaching of the sealing element may preferably include the application of a grouting compound. The grouting compound can be applied, for example, on a surface of the sealing-element support facing away from the temperature-control zone. In this case, a grouting compound adhering to the cell casing can set the position of the storage cell in the recess.

It may be particularly advantageous if:
the storage cell is also received in the recess of a further sealing-element support and
a spacing of the two sealing-element supports is increased while the storage cell is received in the two recesses, and subsequently the setting of the position is undertaken.

It may be particularly advantageous if at least the sealing-element support having a recess in which the storage cell is firstly received exhibits on the recess an insertion slope which extends from a wide region of the recess to a narrow region of the recess, in which case:
the storage cell is received in the recess in such a way that the storage cell firstly reaches the wide region and then reaches the narrow region.

It may be particularly advantageous if the further sealing-element support exhibits a carrier, in which case:
the spacing of the two sealing-element supports is increased, by the storage cell in the recesses being guided toward the carrier and
the further sealing-element support, which is in contact with the storage cell via the carrier, is guided further with the storage cell, increasing the spacing of the two sealing-element supports
and/or
the sealing-element support that does not exhibit a carrier is removed along the cell casing from the further sealing-element support which is in contact with the storage cell via the carrier.

It may be particularly advantageous to set the position of the storage cell in the two recesses of the two sealing-element supports by attachment of a respective sealing element. The attaching of the respective sealing element may include the application of a grouting compound.

It may be preferred to apply a grouting compound firstly on a surface of a sealing-element support facing away from the temperature-control zone, to turn over the cell module being formed, and to apply further grouting compound on a surface of the further sealing-element support facing away from the temperature-control zone.

Alternatively or additionally, a carrier may have been arranged on the storage cell, for example on the cell casing, and the dimensions of the two recesses in which the storage cell is received may have been adapted to the shape of the storage cell and to the carrier in such a way that the carrier passes through only the recess in which the storage cell is firstly received, and only the further sealing-element support, which is in contact with the storage cell via the carrier, is guided further with the storage cell, increasing the spacing of the two sealing-element supports.

Alternatively or additionally, the sealing-element support may include a packing feed opening and a duct region, in which case the duct region extends from the packing feed opening as far as the recess, and in which case the position of the storage cell in the recess is set by attachment of the sealing element, by a liquefied sealing material being conveyed into the recess through the packing feed opening and the duct region.

The duct region may, for example, be bounded by the first support region and by the second support region and may extend between the first support region and the second support region from the packing feed opening as far as the recess.

A direct materially closed connection of a storage cell to at least one molded element can preferably be generated by the at least one molded element being formed on a surface of the storage cell, for example on the cell casing thereof, in the presence of the storage cell, in which case the storage cell is preferably inserted at least partially into a mold in which the at least one molded element is produced, or constitutes a part of the mold in which the at least one molded element is produced. The storage cell may, for example, be the storage cell described herein in connection with the method according to the invention. The molded element may preferably be a molded element described herein. The direct materially closed connection can be generated at the same time between the molded element and a large number of, for example at least 10, further storage cells.

It is, for example, possible that in one method step the storage cell is received in the recess of the sealing-element support, and a position of the storage cell in the recess is set by attachment of a sealing element. This method step may be designated as a seal-in method step.

It is, for example, possible that in one method step the direct materially closed connection of a storage cell to the at least one molded element is generated by the at least one molded element being formed on a surface of the storage cell, for example on the cell casing thereof, in the presence of the storage cell, in which case the storage cell is preferably inserted at least partially into the mold in which the at least one molded element is produced, or constitutes a part of the mold in which the at least one molded element is produced. This method step may be designated as a mold-in method step.

The seal-in method step may preferably be a method step taking place downstream of the mold-in method step.

The mold-in method step may preferably be a method step taking place downstream of the seal-in method step.

At least one further optional method step may take place before, between or after these two method steps.

It is also possible that the method includes a seal-in method step but does not include a mold-in method step.

It is also possible that the method includes a mold-in method step but does not include a seal-in method step.

In accordance with the invention, the object is also achieved by virtue of the features of claim 22.

The force may be, or may include, for example, the gravitational force acting on the storage cell(s).

The force can be selectively transmitted via carriers to one of the two sealing-element supports.

In the course of the displacement of one sealing-element support in relation to the other sealing-element support, a spacing between the sealing-element supports can be increased until the desired extent of a temperature-control zone extending along the cell casing of the storage cell has been obtained.

One or more features that have been described in connection with a subject of the invention—that is to say, in connection with the storage device, with the cell module, with the component set, with the sealing-element support, with the method, or in connection with the use—may preferentially similarly constitute one or more features of another subject of the invention.

Further preferred features and/or advantages of the invention are subjects of the following description and of the diagrammatic representation of embodiments.

### BRIEF DESCRIPTION OF THE DRAWINGS

FIG. 1 shows a schematic representation of a cell module according to the invention, with direction of a view toward the surface of a packing unit;

FIG. 2 shows another schematic representation of the cell module from FIG. 1, with direction of view along a surface of a packing unit;

FIG. 3 shows a section through a schematically represented storage device;

FIG. 4 shows a schematic representation of a detail of a first cell module prior to hot caulking;

FIG. 5 shows a schematic representation of the detail from FIG. 4 after hot caulking;

FIG. 6 shows an enlarged detail from FIG. 5;

FIG. 7 shows a schematic representation of a detail of a second cell module;

FIG. 8 shows a schematic representation of a detail of a third cell module;

FIG. 9 shows a schematic representation of a detail of a fourth cell module;

FIG. 10 shows a schematic representation of a cell module according to the invention, with direction of view along the surfaces of two packing units;

FIGS. 11 and 12 show schematic representations of the production of a cell module according to the invention;

FIG. 13 shows a schematic representation of a cell module according to the invention, obtainable in accordance with FIGS. 11 and 12;

FIG. 14 shows a schematic representation of the application of grouting compound on an upper side in the course of the production of the cell module shown in FIG. 13;

FIG. 15 shows a schematic representation of the application of grouting compound on an underside in the course of the production of the cell module shown in FIG. 13;

FIG. 16 shows a schematic representation of a storage device;

FIG. 17 shows a molded element;

FIG. 18 shows a cross-sectional representation of a further molded element;

FIG. 19 shows a representation of a further molded element; and

FIG. 20 shows a schematic sectional view of a molded-element material, represented in simplified manner, in greatly enlarged representation.

Like or functionally equivalent elements have been provided with the same reference symbols in all the figures.

### DETAILED DESCRIPTION OF THE DRAWINGS

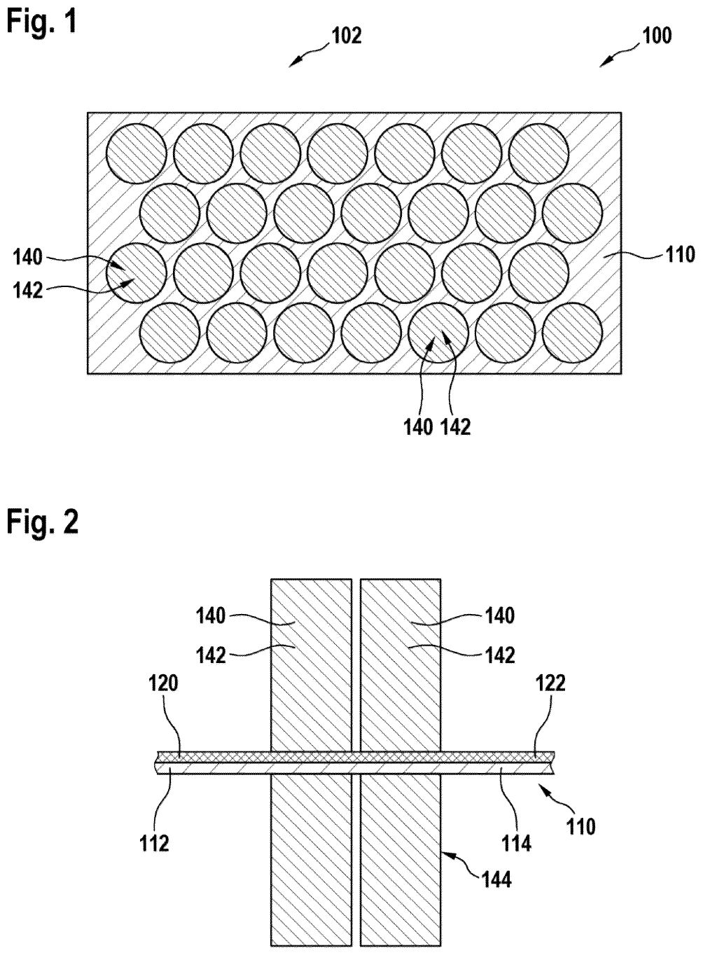

FIG. 1 shows a cell module 100 in the form of a battery-cell module 102. The cell module 100 comprises a large number of storage cells 140, in the form of cylindrical battery cells 142, and a packing unit 110.

FIG. 2 shows a detail of the cell module from FIG. 1 in the direction of view along the surface of the packing unit 110. The packing unit 110 exhibits a sealing element 120 and a sealing-element support 114. In the example shown here, the sealing element 120 has been realized as a sealing-face element 122. The sealing element 120 surrounds the cell casings 144 of the storage cells 140. The sealing-element support 114 is a boundary element 112 which in a storage device 200 may come to be situated in the transition from one temperature-control zone to another temperature-control zone. A respective region of the storage cells 140 then extends into the two temperature-control zones.

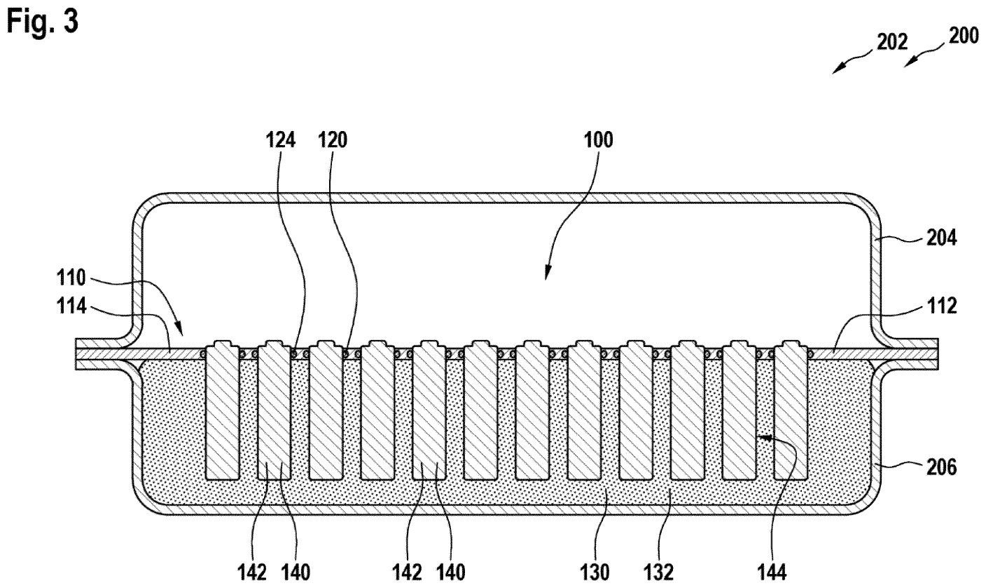

FIG. 3 shows a storage device 200 for receiving, storing and releasing electrical energy. It is a question of a battery device 202 which includes a cell module 100. The storage device 200 includes a large number of storage cells 140. The storage cells are cylindrical battery cells 142. The storage device 200 also includes a packing unit 110. The packing unit 110 exhibits a large number of sealing elements 120. The sealing elements 120 are packing rings 124. The storage device 200 also includes a temperature-control zone 130 on one side of the packing unit 110. A respective region of the storage cells 140 extends into the temperature-control zone 130 in which the storage cells are flowed around by a temperature-control fluid 132. Each sealing element 120 surrounds a cell casing 144 of a storage cell 140 and, together with the sealing-element support 114 acting as boundary element 112, delimits the temperature-control zone 130 from an adjacent zone. In FIG. 3, the adjacent zone is represented above the packing unit 110. The housing of the storage device comprises the upper housing element 204 and the lower housing element 206.

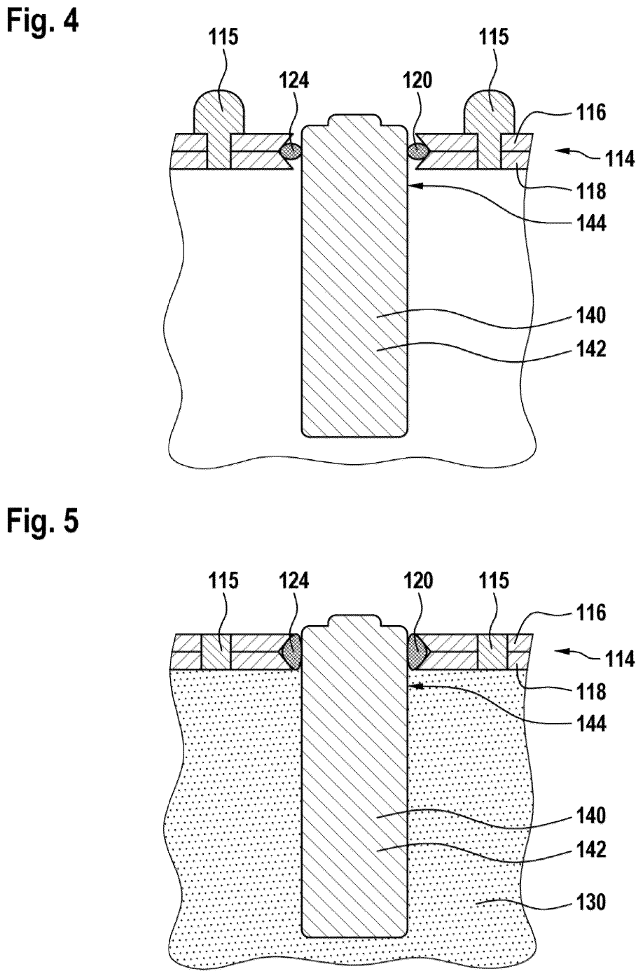

FIGS. 4 to 9 show, in exemplary manner, various possibilities for arranging storage cells 140 in storage devices 200 and cell modules 100.

FIGS. 4 and 5 illustrate one possibility for pressing a sealing element 120, which may be a packing ring 124, particularly firmly against the cell casing 144. FIG. 4 shows a state prior to the hot pressing. FIG. 5 shows a state after the hot pressing. In FIG. 5, the sealing element 120 is pressed against the cell casing 144 by the sealing-element support 114. For this purpose, the fusible and/or flowable mass of the hot-pressing element 115, which in FIG. 4 is represented in its original shape, was hot-pressed into the plane of the sealing-element support.

The sealing-element support 114 comprises a first support region 116 and a second support region 118. A region of the sealing element 120 is arranged between the two support regions 116 and 118.

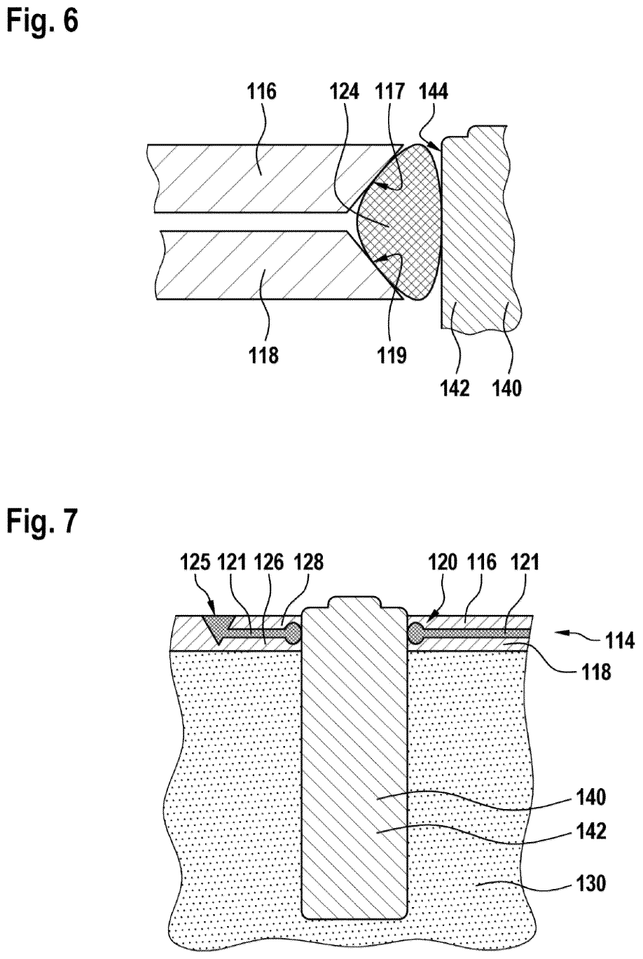

FIG. 6 shows an enlarged detail from FIG. 5. An edge 117 on the margin of the first support region 116 and an edge 119 on the margin of the second support region 118 have been formed in such a way that the region of the sealing element 120 that is arranged between the two support regions 116 and 118 is received in a depression defined by the two edges 117 and 119. In the example shown, the edges 117 and 119 are inclined toward one another.

The edge 117 of the first support region 116 and the edge 119 of the second support region 118 bear against the sealing element 120. Due to the inclination of the edges 117 and 119 and the force that is built up in the course of the hot pressing, the two support regions 116 and 118 may have been splayed, as shown in FIG. 6. The initial tension of the support regions 116 and 118 which has been built up in this process contributes to the outcome that the sealing element 120 is pressed against the cell casing 144.

By virtue of the hot pressing, it can be ensured in particularly straightforward manner that the storage cell 140 is seated very firmly in the packing unit 110. Even a force F acting along a longitudinal axis of the storage cell that corresponds to 20 times or even 50 times the magnitude of a weight force G acting on the storage cell 140 is then not sufficient to pull the storage cell 140 out of the pressed-on sealing element 120.

The first and second support regions 116 and 118 may be separate plate elements. Depending upon the choice of the materials of the plate elements and of the hot-caulking element 115, the hot caulking may have the result that the support regions 116 and 118 are connected to one another in a connection region by force closure, by form closure and/or by material closure.

In the example shown in FIG. 7, the first support region 116 is a cover region 128, and the second support region 118 is a base region 126. A packing portion 121 of the sealing element 120 extends between the cover region 128 and the base region 126. The sealing element 120 is connected to the sealing-element support 114 by material closure. In particular, the packing portion 121 is connected to the cover region 128 and to the base region 126 by material closure. The sealing element 120 is also attached by material closure to a surface of the sealing-element support 114 facing toward the cell casing 144. The sealing-element support 114 includes a packing feed opening 125 and a duct region which extends from the packing feed opening 125 as far as the recess 240 and is bounded by the first support region 116 and by the second support region 118. In the example shown, a liquefied packing material was introduced through the packing feed opening 125 and the duct region, and as a result the sealing element 120, linked to the sealing-element support 114 by material closure, was also formed.

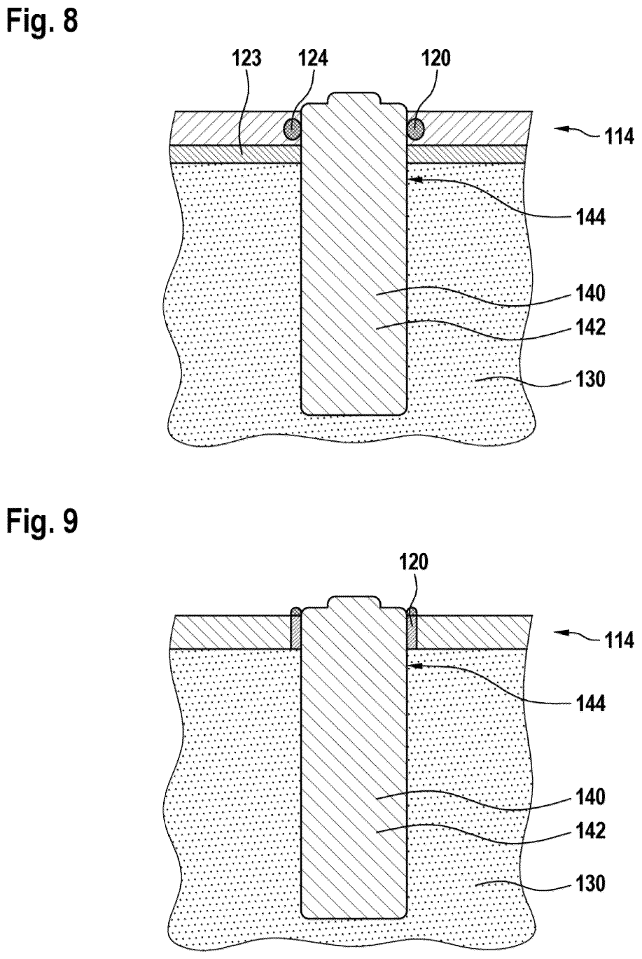

In the example shown in FIG. 8, a planar retaining element 123 is arranged on a surface of the sealing-element support 114 that faces toward the temperature-control zone 130. The planar retaining element 123 surrounds the cell casing 144; it is spaced from the sealing element 120. In the example shown, the planar retaining element 123 has been formed from a grouting compound. The retaining element 123 may develop an additional sealing action.

In the example shown in FIG. 9, the sealing element 120 has been attached in materially closed manner by injection molding to a surface of the sealing-element support 114 facing toward the cell casing 144.

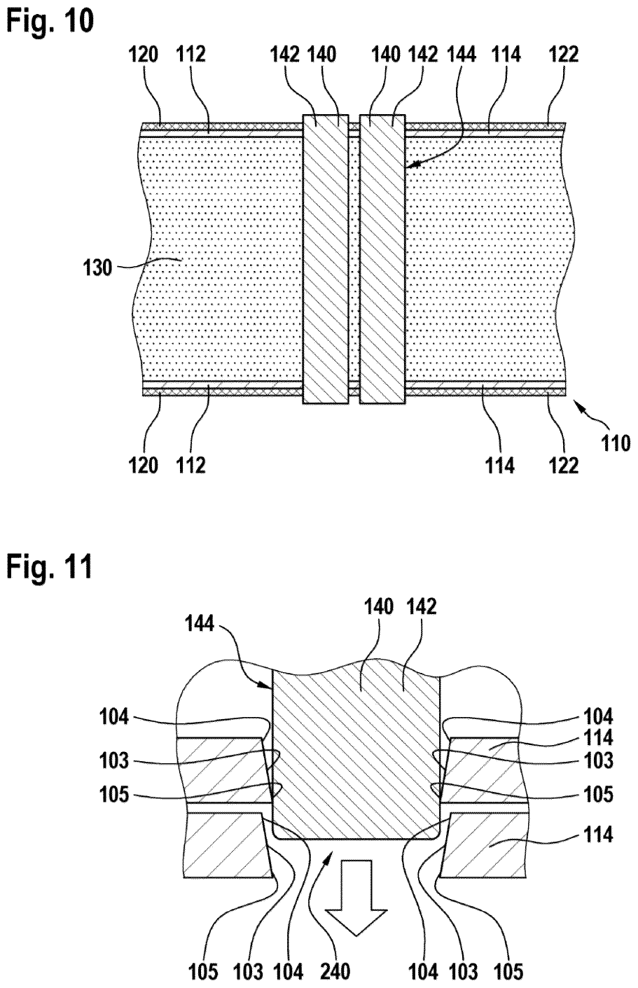

FIG. 10 shows, by way of example, two storage cells 140, for example battery cells 142, of a cell module, with direction of view along the surfaces of two packing units 110.

One packing unit 110 is arranged at one end of the storage cells 140. The other packing unit 110 is arranged at the other end of the two storage cells 140.

The packing units 110 each include a sealing-element support 114 which in each instance acts as a boundary element 112. This is because the sealing-element supports bound a temperature-control zone 130.

The packing units 110 each include, in addition, a sealing element 120 which here takes the form of a sealing-face element 122 in each instance. As becomes clear from the statements relating to the following FIGS. 11 to 14, it may be a question of a sealing-face element 122 formed from a grouting compound 127.

FIG. 11 illustrates how the reception of a storage cell in recesses 240, arranged on top of one another in alignment, of two sealing-element supports 114 can be effected.

The two sealing-element supports 114 may have been arranged closer together to begin with; for example, one sealing-element support may be situated on the other sealing-element support, as indicated in FIG. 11.

The sealing-element supports 114 each exhibit an insertion slope 103 on the recesses 240 thereof.

The insertion slopes 103 extend from a wide region 104 of the respective recess 240 to a narrow region 105 of the respective recess 240.

The storage cell 140 is received in the recesses 240, one after the other, downward in the direction of the arrow in such a way that the storage cell firstly reaches the wide region 104 and then reaches the narrow region 105 of the respective recess.

The dimensions of one narrow region 105 or of both narrow regions 105 may have been adapted to the external dimensions of the cell casing 144 in such a way that there is no risk of the storage cell 140 getting stuck in the narrow region 105 or in the narrow regions 105, and of a grouting compound 127 to be applied later being able to flow away between the cell casing 144 and the narrow region 105.

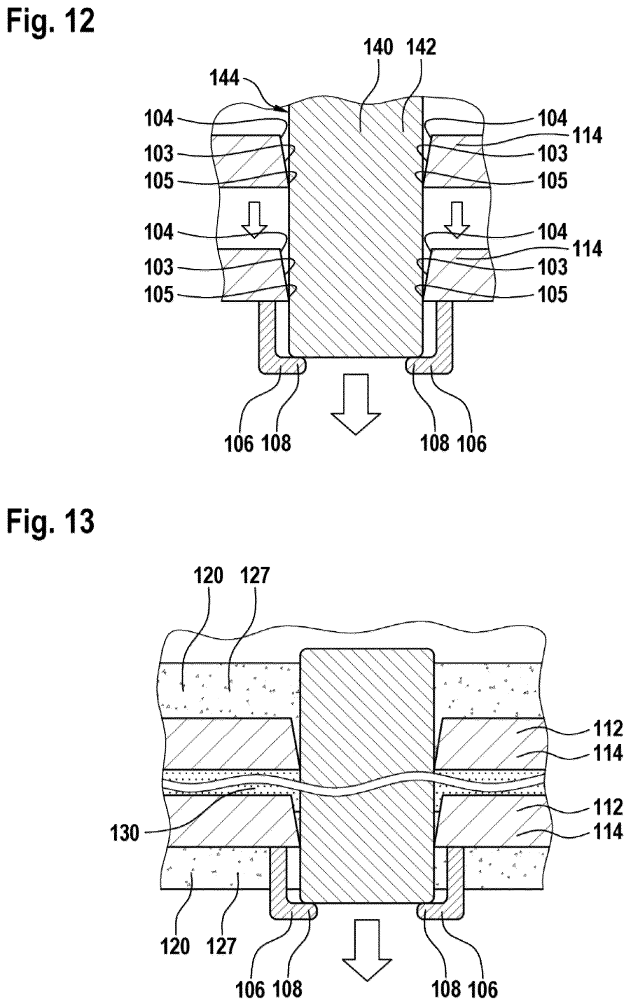

FIG. 12 illustrates how a spacing of the two sealing-element supports 114 can be increased while the storage cell 140 is received in the two recesses 240.

A sealing-element support 114 exhibits a carrier 106 which was omitted in FIG. 11. The spacing of the two sealing-element supports 114 is increased, by the storage cell 140 being guided in the recesses 240 toward the carrier 106, and by only the sealing-element support 114 which is in contact with the storage cell 140 via the carrier 106 and which is represented at the bottom in FIG. 12 being guided further with the storage cell 140, increasing the spacing of the two sealing-element supports.

In the example shown, the carrier 106 constitutes a storage-cell stop 108 which sets a maximum reception depth of a storage cell 140 that is capable of being received in the recess.

The schematic representation of a cell module according to the invention, obtainable in accordance with FIGS. 11 and 12, that is shown in FIG. 13 represents in exemplary manner only one individual storage cell 140.

In advantageous cell modules 100 according to the invention, adjacent storage cells 140 may be located in the immediate vicinity of the storage cell 140, in which case the cell casings 144 may be, for example, only 1 mm to 2 mm away from one another. For the sake of simplicity, however, adjacent storage cells 140 and the associated adjacent recesses 240 have not been shown in FIG. 13.

FIG. 13 shows that a grouting compound 127 is arranged on each of the surfaces of the two sealing-element supports 114 facing away from the temperature-control zone 130. The grouting compound 127 constitutes a sealing element 120 in each instance and connects the cell casing 144 to the two surfaces of the two sealing-element supports 114 facing away from the temperature-control zone 130.

The grouting compound 127 also connects the cell casing 144 to the insertion slope 103 of the sealing-element support 114 represented at the top in FIG. 13. The grouting compound 127 can get there through the wide region 104 of the sealing-element support 114 represented at the top in FIG. 13.

It is possible that the grouting compound 127 also connects the cell casing 144 to the insertion slope 103 of the sealing-element support 114 represented at the bottom in FIG. 13. For instance, the connection may be constituted by a bit of grouting compound 127 which has seeped through the narrow region 105 of the sealing-element support represented at the bottom in FIG. 13.

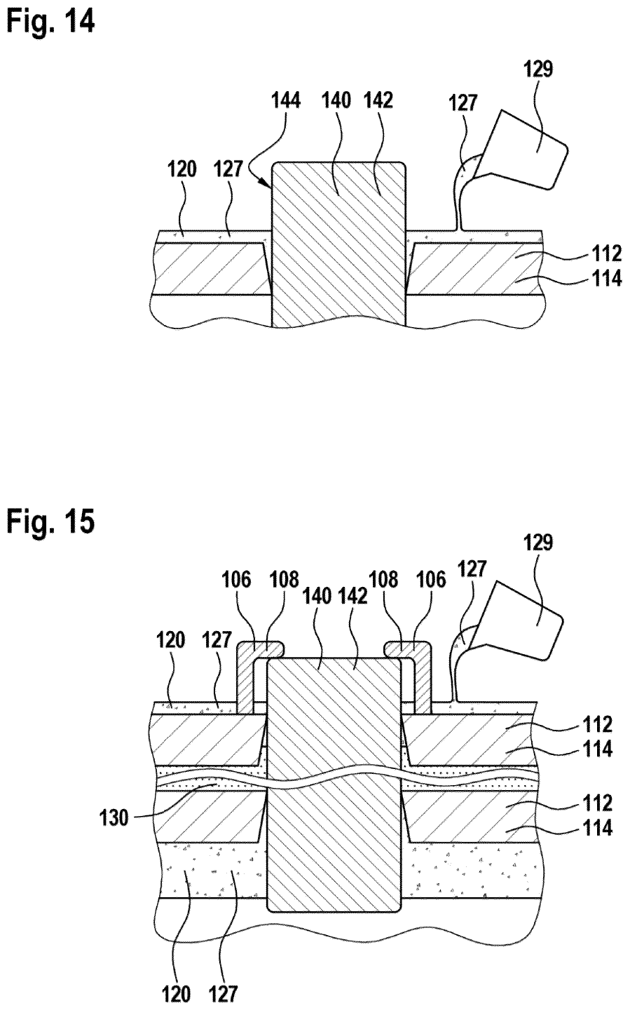

FIG. 14 represents the application of grouting compound 127 from a grouting-compound source 129 on an upper side. For example, the application can be undertaken in the course of the production of the cell module shown in FIG. 13. After the spacing of the two sealing-element supports 114 has been increased to a desired extent, the position of the storage cell 140 in the recess can be set by attachment of a sealing element 120, in which case the attachment of the sealing element 120 in the example shown here is undertaken by the application of a grouting compound 127, and the grouting compound 127 constitutes the sealing element 120.

FIG. 15 shows the cell module arising in a turned-over state which enables an application of grouting compound 127 from the grouting-compound source 129 on the underside (now oriented upward). The position of the storage cell 140 in the recess of the sealing-element support 114 now represented at the top can also be set by attachment of a sealing element 120, in which case the attachment of the sealing element 120 in the example shown here is undertaken by the application of a grouting compound 127, and the grouting compound 127 constitutes the sealing element 120.

In the example shown here, a bit of grouting compound 127 which has seeped through the narrow region 105 also connects the cell casing 144 to the insertion slope 103 of the sealing-element support 114 represented at the bottom in FIG. 13.

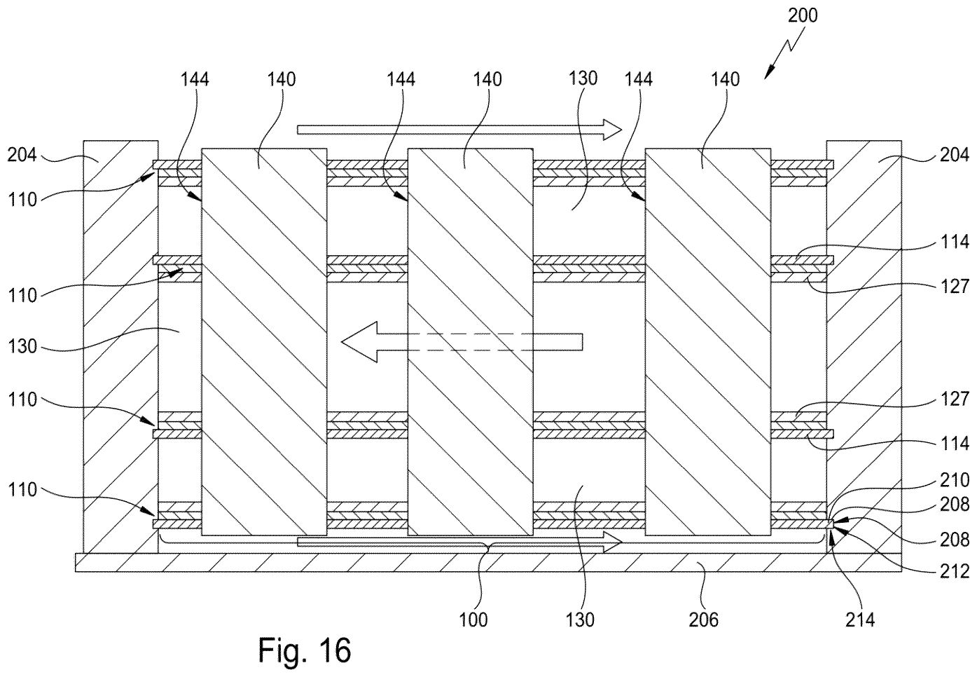

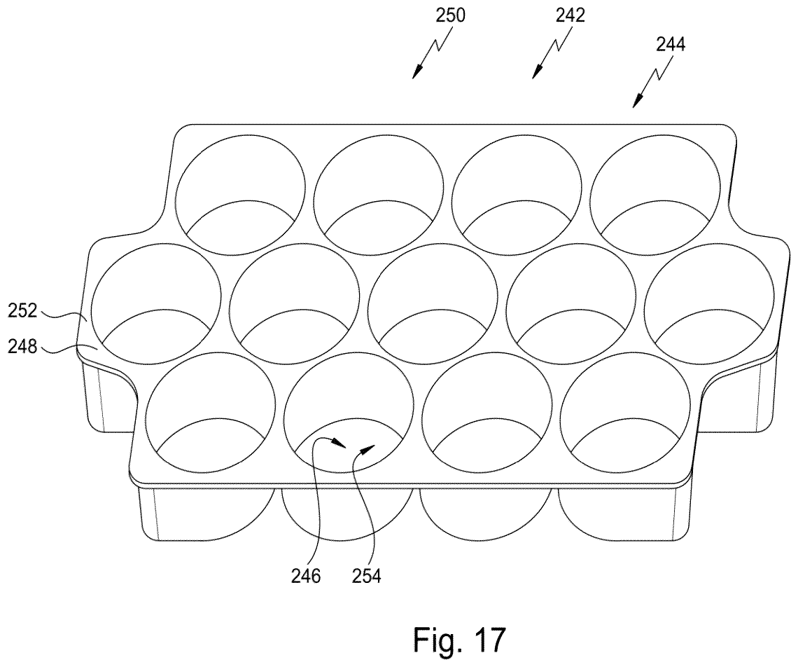

FIG. 16 shows a storage device 200 in a schematic sectional representation, wherein, in particular, the spacings of the storage cells 140 have been represented in exaggeratedly large manner.

The storage device 200 shown in FIG. 16 may serve for receiving, storing and releasing electrical energy. The storage device comprises a large number of storage cells 140, only three of which are shown in the schematic representation.

The storage device 200 includes four packing units 110, each packing unit 110 exhibiting a sealing element.

The storage device also includes temperature-control zones 130 which each extend on one side or on both sides of packing units 110. Regions of the storage cells 140 extend into the temperature-control zones 130 or through some of the temperature-control zones 130.

The sealing elements surround cell casings of the storage cells 140. They respectively delimit adjacent temperature-control zones 130 from one another.

The packing units 110 each exhibit a sealing-element support 114.

In the example of a storage device shown in FIG. 16, a grouting compound 127 constitutes the respective sealing element. The grouting compound connects the storage cells 140 to the respective sealing-element support 114. Insertion slopes may likewise have been provided. However, they have not been represented in FIG. 16.

The packing units 110 are arranged in suspension zones 214 on at least one housing element 204 of the storage device 200. For this purpose, the at least one housing element 204 and the respective packing unit 110 may each exhibit at least one suspension element 208. In the example shown in FIG. 16, a suspension element 208 of the at least one housing element 204 is at least one suspension depression 212 in which, in each instance, at least one suspension projection 210 of a packing unit 110, acting as suspension element 208, may have been received.

The packing units 110 in the storage device have each been represented in three layers. FIG. 16 shows merely one possibility, in which the respective sealing-element support 114 exhibits at least one suspension projection 210. Other layer structures are likewise possible. For example, the middle layer in each instance might constitute a sealing-element support 114, and the two layers arranged thereon might have been formed from, or consist of, grouting compound 127.

FIG. 16 shows that several regions of the storage cells succeeding one another along the longitudinal axes of the several storage cells 140 extend into adjacent temperature-control zones 130 of the storage device. One or more inlets, conduits and outlets, not shown, may have been formed in such a way that the main flow directions of a temperature-control fluid extend, for example, as indicated by the arrows in FIG. 16. In various temperature-control zones 130 a temperature-control fluid can be conducted in substantially the opposite direction.

FIG. 17 shows a molded element 242. The molded element is suitable for arrangement in a storage device 200 or in a cell module 100.

The molded element 242 may preferably have been arranged in a storage device 200, for example in a storage device 200 that is shown in FIG. 16.

The molded element can, for example, be inserted in the storage device in place of one or more packing units 110 and may take up some of the volume of one or more temperature-control zones 130.

The molded element 242 may be a packing unit 110.

The molded element 242 includes several receiving zones 246. The receiving zones 246 are suitable for receiving at least one portion of a respective storage cell 140 in the molded element 242. In this case, the receiving zones may serve as guide zones 254.

In the example shown here, the molded element 242 consists entirely of a molded-element material 248. The density of the molded-element material 248 preferably amounts to less than 0.55 g/cm³.

In the example shown here, the molded-element material 248 is a particle-foam material 252, which may be a synthetic particle-foam material.

In the case of the molded element 242 represented in FIG. 17, the molded-element material 248 takes up the entire volume of the molded element 242. The molded element 242 shown therein is a synthetic molded element 244.

The synthetic molded element 244 has been obtained by molding. In this process, particles 264 exhibiting voids, for example pores 268, were introduced into a mold. The particles 264 introduced into the mold were thermoplastic microparticles exhibiting closed pores—that is to say, a form of synthetic particles 266. In the mold they were converted into the molded element 242 by supply of heat. The temperature of this process was adjusted in such a way that the thermoplastic became sufficiently soft, and as a result of this the thermoplastic material was connected to particle surfaces of adjacent particles. Alternatively, a wetting of particles 264 exhibiting voids, for example pores 268, with an adhesion-promoter, with the aid of which a connection of the particles can be effected, would be possible.

A direct materially closed connection of a storage cell 140 to at least one molded element 242 can preferably be generated by the at least one molded element 242 being formed on the cell casing 144 in the presence of the storage cell 140. For this purpose, the storage cell 140 is partially inserted into a mold in which the at least one molded element 242 is produced. Alternatively, the storage cell 140 may constitute a part of the mold in which the at least one molded element 242 is produced.

In the case of the molded element 242 shown in FIG. 17, the receiving zones 246 are cylindrical receiving zones. They each include a cylindrically encircling receiving-zone surface.

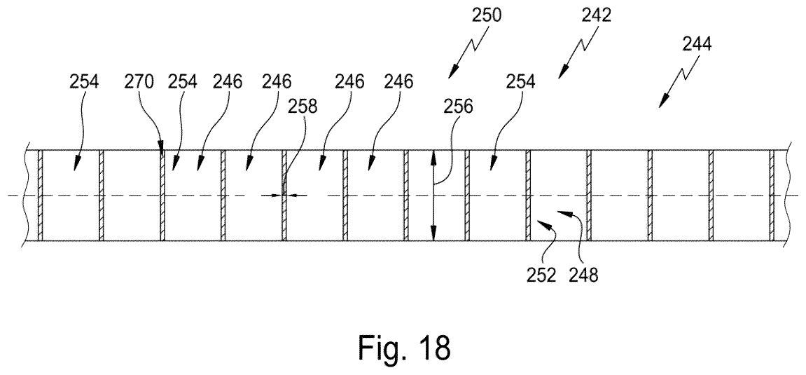

FIG. 18 shows a portion of a planar molded element 242 in a sectional representation.

In FIG. 18 too, receiving zones 246 can be discerned. The receiving zones 246 are each suitable for receiving a portion of a storage cell 140 in the molded element 242. The molded element 242 shown in FIG. 18 is also a synthetic molded element 244.

The molded element shown in FIG. 18 includes wall zones 270. The wall zones 270 are each arranged between two directly adjacent receiving zones 246. The wall zones 270, like the rest of the molded element 242, consist of the molded-element material 248 which, for example, may be a particle-foam material 252.

FIG. 18 shows a least material thickness 258. The least material thickness 258 is measured between two receiving zones 246. Between the receiving zones the molded-element material 248 tapers to the least material thickness 258. The least material thickness 258 can be measured at the point where the spacing between the cylindrically encircling receiving-zone surfaces of two adjacent receiving zones 246 is particularly small.

In the case of the molded element 242 shown in FIG. 18, a material thickness 256 which is measured orthogonally to a median plane, represented in dashed manner, of the planar molded element 242 is distinctly larger than the least material thickness 258 which is measured in the median plane of the planar molded element 242.

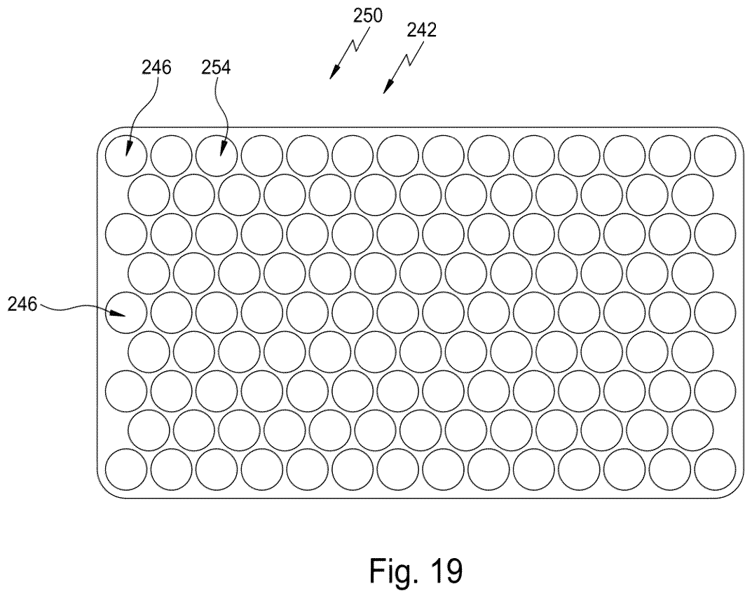

FIG. 19 shows a further molded element 242. In FIG. 19, the direction of view of the observer is oriented parallel to the receiving direction in which storage cells 140 not represented in FIG. 19, for example battery cells 142, can be received in the receiving zones 246 shown. The cylindrical receiving zones 246 therefore appear as circles in the view shown in FIG. 19.

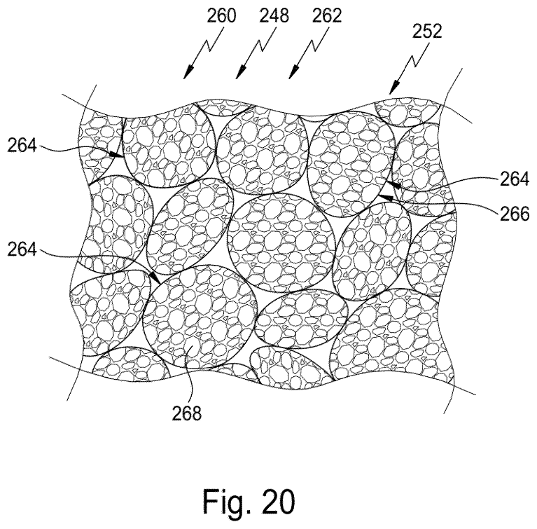

FIG. 20 shows a schematic representation of a section through a molded-element material 248 represented in simplified manner. The section has been represented in greatly enlarged manner. The molded-element material 248 shown therein is a molded-element synthetic material 260.

The molded-element material 248 exhibits voids. The voids are pores 268 which are inaccessible to a surrounding fluid. The molded-element material 248 contains particles 264 which are synthetic particles 266. The particles 264 have been fused together on the surfaces thereof.

The particles 264 exhibit the pores 268. The particle-foam material 252 has been built up from multicellular particles. The molded-element synthetic material 260 is a particle-foam material 252 which may also be designated as particle foam 262.

### List of Reference Symbols

Cell module 100

Battery-cell module 102

Insertion slope 103

Wide region 104

Narrow region 105

Carrier 106

Storage-cell stop 108

Packing unit 110

Boundary element 112

Sealing-element support 114

Hot-caulking element 115

Support region 116

Edge 117

Support region 118

Edge 119

Sealing element 120

Packing portion 121

Sealing-face element 122

Retaining element 123

Packing ring 124

Packing feed opening 125

Base region 126

Grouting compound 127

Cover region 128

Grouting-compound source 129

Temperature-control zone 130

Temperature-control fluid 132

Storage cell 140

Battery cell 142

Cell casing 144

Storage device 200

Battery device 202

Housing element 204

Housing element 206

Suspension element 208

Suspension projection 210

Suspension depression 212

Suspension zone 214

Recess 240

Molded element 242

Synthetic molded element 244

Receiving zone 246

Molded-element material 248

Guide element 250

Particle-foam material 252

Guide zone 254

Material thickness 256

Material thickness 258

Molded-element synthetic material 260

Particle foam 262

Particles 264

Synthetic particles 266

Pores 268

Wall zone 270

1. A storage device for receiving, storing and releasing electrical energy, the storage device comprising the following:
a storage cell;
a packing unit, the packing unit exhibiting a sealing element;
and a temperature-control zone on one side of the packing unit, with at least one region of the storage cell extending into the temperature-control zone;
wherein the sealing element surrounds a cell casing of the storage cell and delimits the temperature-control zone from an adjacent zone.

2. The storage device as claimed in claim 1, wherein the packing unit exhibits a sealing-element support.

3. The storage device as claimed in claim 1, exhibiting a grouting compound, wherein
the grouting compound constitutes the sealing element,
the grouting compound connects the sealing element to the sealing-element support, and/or
the grouting compound connects the storage cell to the sealing-element support.

4. The storage device as claimed in claim 2, wherein the sealing-element support exhibits an insertion slope, the insertion slope faces toward the cell casing and is inclined in relation to the surface of the cell casing, and the insertion slope preferably extends around the cell casing.

5. The storage device as claimed in claim 1, wherein the region of the storage cell extends through the temperature-control zone as far as a further packing unit, and both packing units preferably each exhibit a sealing-element support.

6. The storage device as claimed in claim 5, wherein a grouting compound is arranged at least on a surface of a sealing-element support facing away from the temperature-control zone, the grouting compound constitutes a sealing element and connects the cell casing to the surface of the sealing-element support facing away from the temperature-control zone, and/or to the insertion slope.

7. The storage device as claimed in claim 5, wherein at least one packing unit, for example the further packing unit, is a molded element, and/or the temperature-control zone is bounded by a molded element,
wherein the molded element comprises a molded-element material, and the density of the molded element amounts to at most 0.75 g/cm³, preferably amounts to at most 0.65 g/cm³, optionally preferably amounts to at most 0.55 g/cm³,
wherein it is preferred if the molded-element material exhibits voids, for example pores,
wherein it is optionally preferred if the molded-element material contains particles and the particles exhibit voids, for example pores,
wherein the molded-element material may be, for example, a particle-foam material.

8. A cell module, for example for a storage device as claimed in claim 1, the cell module comprising the following:
a storage cell;
a packing unit, the packing unit exhibiting a sealing element and a sealing-element support;
wherein the sealing element surrounds a cell casing of the storage cell.

9. The cell module as claimed in claim 8, exhibiting a grouting compound, wherein
the grouting compound constitutes the sealing element,
the grouting compound connects the sealing element to the sealing-element support, and/or
the grouting compound connects the storage cell to the sealing-element support.

10. The cell module as claimed in claim 8, wherein the sealing-element support exhibits an insertion slope, the insertion slope faces toward the cell casing and is inclined in relation to the surface of the cell casing, and the insertion slope preferably extends around the cell casing.

11. The cell module as claimed in claim 8, wherein the cell module includes, in addition:
a further packing unit, the further packing unit exhibiting a further sealing element and a further sealing-element support;
wherein the further sealing element also surrounds the cell casing of the storage cell and
wherein a region of the storage cell extends between the packing units through a temperature-control zone which is bounded by the two packing units.

12. The cell module as claimed in claim 11, wherein a grouting compound is arranged at least on a surface of a sealing-element support facing away from the temperature-control zone, the grouting compound constitutes a sealing element and connects the cell casing to the surface of the sealing-element support facing away from the temperature-control zone, and/or to the insertion slope.

13. The cell module as claimed in claim 8, wherein at least one packing unit, for example the further packing unit, is a molded element, and/or a temperature-control zone is bounded by a molded element,
wherein the molded element comprises a molded-element material, and the density of the molded element amounts to at most 0.75 g/cm³, preferably amounts to at most 0.65 g/cm³, optionally preferably amounts to at most 0.55 g/cm³,
wherein it is preferred if the molded-element material exhibits voids, for example pores,
wherein it is optionally preferred if the molded-element material contains particles and the particles exhibit voids, for example pores,
wherein the molded-element material may be, for example, a particle-foam material.

14. A component set for producing a storage device, the component set comprising two sealing-element supports which exhibit recesses for receiving a storage cell, wherein
one sealing-element support exhibits, on the recess thereof, an insertion slope, and
the other sealing-element support exhibits a carrier, the carrier permitting reception of a storage cell in the recess of this sealing-element support but preventing the storage cell that is capable of being received from sliding completely through the recess of this sealing-element support.

15. The component set as claimed in claim 14, wherein the carrier constitutes a storage-cell stop which sets a maximum reception depth of a storage cell that is capable of being received in the recess.

16. A sealing-element support for producing a storage device or for a component set, the sealing-element support exhibiting several recesses for receiving storage cells, wherein
the sealing-element support exhibits an insertion slope on at least one recess and the spacing between directly adjacent recesses amounts to at most 5 mm.

17. A method for producing a storage device or a cell module, wherein:
a sealing-element support is provided which exhibits a recess for receiving a storage cell,
the storage cell is received in the recess and
a position of the storage cell in the recess is set by attachment of a sealing element, in which the attachment of the sealing element may include the application of a grouting compound.

18. The method as claimed in claim 17, wherein:
the storage cell is also received in the recess of a further sealing-element support and
a spacing of the two sealing-element supports is increased while the storage cell is received in the two recesses, and subsequently the setting of the position is undertaken.

19. The method as claimed in claim 17, wherein at least the sealing-element support having a recess in which the storage cell is firstly received exhibits on the recess an insertion slope which extends from a wide region of the recess to a narrow region of the recess, wherein:
the storage cell is received in the recess in such a way that the storage cell firstly reaches the wide region and then reaches the narrow region.

20. The method as claimed in claim 18, wherein the further sealing-element support exhibits a carrier, wherein:
the spacing of the two sealing-element supports is increased, by the storage cell in the recesses being guided toward the carrier, and
the further sealing-element support, which is in contact with the storage cell via the carrier, is guided further with the storage cell, increasing the spacing of the two sealing-element supports and/or
the sealing-element support that does not exhibit a carrier is removed along the cell casing from the further sealing-element support, which is in contact with the storage cell via the carrier.

21. The method as claimed in claim 18, wherein a carrier is arranged on the storage cell, for example on the cell casing, and the dimensions of the two recesses in which the storage cell is received have been adapted to the shape of the storage cell and to the carrier in such a way that the carrier passes through only the recess in which the storage cell is firstly received, and only the further sealing-element support which is in contact with the storage cell via the carrier is guided further with the storage cell, increasing the spacing of the two sealing-element supports.

22. A method for producing a storage device or a cell module,
wherein a direct materially closed connection of a storage cell to at least one molded element is generated by the at least one molded element being formed on a surface of the storage cell in the presence of the storage cell, wherein the storage cell is preferably inserted at least partially into a mold in which the at least one molded element is produced, or constitutes a part of the mold in which the at least one molded element is produced.

23. The use of a storage cell for transmitting a force, wherein by virtue of the force one sealing-element support is displaced in relation to another sealing-element support.

24. The use as claimed in claim 23, wherein in the course of the displacement of one sealing-element support in relation to the other sealing-element support a spacing between the sealing-element supports is increased until the desired extent of a temperature-control zone extending along the cell casing of the storage cell has been obtained.
